(19) United States
(12) Patent Application Publication
(10) Pub. No.: US 2004/0060224 A1
(43) Pub. Date: Apr. 1, 2004

(54) Blade structures for use with fishhooks and artificial lures, as well as method of creating an artificial lure incorporating same

(76) Inventor: James Churches, Nederland, CO (US)

Correspondence Address: TIMOTHY J MARTIN, PC, 9250 W 5TH AVENUE, SUITE 200, LAKEWOOD, CO, 80226, US

(21) Appl. No.: 10/263,301

(22) Filed: Oct. 1, 2002

(51) Int. Cl. A01K 85/00

(52) U.S. Cl. 43/42.53

(57) ABSTRACT

Artificial lures, fishhook constructions, and a method for creating the same are provided. The fishhook has a shank portion attachable to a fishing line, a bend portion extending arcuately from the shank to terminate in a pointed tip, and a blade projecting from the shank. When used in conjunction with an artificial lure, the blade imparts movement to the lure to improve its presentation in the water. There may be two blades positioned in opposed relationship that diverge away or converge toward one another. Alternately, the blades may be staggered along the length of the shank. The blade(s) may be joined to the shank with a binding member that may be a slotted piece molded about the shank and having circumferential grooves formed therein. The blade and binding member may be plastic and formed as a single piece construction or as two separate pieces.

### FIELD OF THE INVENTION

The present invention broadly relates to the field of fishing and more particularly concerns artificial lures and hook constructions for use in the sport of fly fishing. The present invention also pertains to improvements to known hook constructions and the creation of artificial lures.

### BACKGROUND OF THE INVENTION

Fishing is an outdoor activity that mankind has participated in for centuries. Indeed, fishing was an integral aspect of many primitive cultures and becoming an accomplished fisherman was vital to ensuring survival and prosperity. While becoming a proficient angler is far less necessary today for ensuring survival, it nonetheless remains an integral part of many cultures throughout the world. In recent years, fishing has evolved into an activity that has enjoyed widespread popularity for sportsmen and avid enthusiasts alike. This is particularly true since so many different types of waterways, such as oceans, lakes, rivers and streams, can provide a habitat for different species of fish. As with other popular outdoor activities, the consumer fisherman is inundated with a plethora of fishing-related products, such as gear, accessory items, literature, videos, etc., directed to virtually every aspect of the sport. The overwhelming objective behind the vast majority of these products is quite simply to improve one's chances of catching fish.

Perhaps the two most popular forms of fishing today entail the use of a fishing rod in the form of either a spinning rod having an associated open-face spinning reel or a fly fishing rod with an associated fly reel, but the techniques for using these two types of implements can vary markedly. Some of these differences reside, for example, in the manner in which a fishing lure is cast, how the rod is manipulated in order to best present the lure to a target fish, and how the rod is manipulated in order to land the fish. In the United States and throughout many other regions in the world, various types of fish of the salmonids family, including a variety of different salmon and trout species that inhabit streams, rivers and other waterways, are the catch of choice for anglers. While many avid fishermen would advocate the use of a fly rod as the most effective tool for catching these species of fish, it is also common to rig the traditional spinning rod as one means of catching them.

While experience has demonstrated over time that fish can be caught using a variety of different techniques, it is well recognized that certain considerations can contribute to one's success rate. For example, by recognizing some of the species' fundamental survival instincts, such as protection from prey, convenient accessibility to food, and energy conservation, an accomplished fisherman can often ascertain likely locations for fish even though they cannot actually be seen. Another consideration is selection of suitable bait for the fish, whether an artificial lure or live bait. This is particularly true for trout and other fish of the salmonid family which, depending on such things as location, season, time of day, and environmental conditions, might have any of a variety of food sources available to them.

In any event, once an angler selects a suitable fly or other type of artificial lure, proper presentation of the lure to a target fish or quarry of fish can be vital to one's success rate. While the concept of what constitutes a proper presentation of an artificial lure to a fish has been debated, it is generally recognized that it is important to present the lure in a manner that appears realistic to the fish. In order to accomplish this, consideration should be given to the conditions of the waterway, the location and depth of the fish, and the placement and action of the artificial lure, among other factors. Moreover, a knowledgeable angler might need to accessorize his rigging with weight, indicators and/or floatant which, combined with different casting and line manipulation techniques, can work in conjunction with one another to provide a proper presentation of the fly to the fish.

Whether by regulation or choice, many anglers such as fly fishermen regularly utilize an artificial lure for attracting and catching such fish. In fact, an entire industry has evolved directed to the production of artificial lures for simulating various aquatic life forms, such as aquatic flies, bugs, small fish, leaches, salamanders, frogs, and crustaceans which are important to a fish's diet. While numerous species of aquatic insects exist, perhaps the most important ones for fly fishing are mayflies, caddidsflies, stone flies and midges. Depending on the particular species and time of year, these aquatic flies might exist in variety of different life stages that are important to fly fishermen.

The artificial lure itself can have a variety of different patterns. Imitation patterns, for example, are aimed at replicating (through size, shape and color) a particular stage in the life cycle of a given aquatic life form. Other types of patterns, known as suggestive patterns, are aimed at representing a variety of related species of aquatic life forms. While imitation fly patterns can prove very successful when, for example, attempting to emulate a particular insect hatch which may be occurring on a river, suggestive patterns can oftentimes be more successful since they can suggest any of a variety of different life forms which a trout may encounter on a given day.

Various modifications have been made over the years to the design and construction of artificial lures. One such modification which has found particular suitability for artificial lures used in conjunction with traditional spinning rods and reels is the utilization of a blade or blade-like structure, resembling a fin, projecting from the body of the lure to provide added movement to it as it is drawn through the water. Where fly fishing is concerned, available patterns for artificial lures in general, and artificial flies in particular, are virtually limitless and various fly tying materials and arrangements can be employed which affect the look, bounce, and movement of the fly when it is in the water. Advances have also been made relating to the fishhooks upon which a desired fly pattern is tied, including the materials from which the fishhooks are constructed and their design. While such modifications had received wide spread success, it has not been known to incorporate such a blade-like structure on the construction of a hook, itself, let alone a hook intended for use in the fly fishing industry as a component to an artificial fly fishing lure upon which a desired fly pattern is tied.

Accordingly, despite the numerous developments over the years in the industry, there remains a need to provide an improved construction for an artificial lure so that it can better simulate the life-like movement of an aquatic life form through water and thus increase one's chances of catching fish. There is a particular need to provide an improved hook construction for use in an artificial fly fishing lure which works in conjunction with the aquatic life form pattern to enhance its life-like appearance in the water. The present invention is directed to meeting these needs, among others.

### SUMMARY OF THE INVENTION

It is an object of the present invention to provide a new and improved fishhook for use in the sport of fishing and preferably one which is particularly suited for fly fishing.

Another object of the present invention is to provide a new and improved artificial fishing lure for resembling the appearance of a selected aquatic insect at a particular stage of its life or various other aquatic life forms, such as small fish, leaches, salamanders, crustaceans, and frogs, as well as a method for creating the same.

A further object of the present invention is to provide such an artificial lure which, during use, interacts with moving water to impart movement to the lure simulating life-like motion of a selected aquatic insect.

Yet another object of the present invention is to provide a fishhook and an artificial lure which are simplified in construction, relatively easy to manufacture and relatively inexpensive.

Still a further object of the present invention is to provide a blade structure for use with a fishhook and an artificial lure.

A still further object of the present invention is to provide a fishhook construction utilizing the invention that is suitable for bait fishing.

In accordance with these objectives, the present invention broadly concerns fishhooks, artificial lures, and blade structures, having a variety of possible constructions that impart life-like movement to an artificial fly while fishing. While the present invention is particularly described herein with reference to artificial fly fishing lures (and their associated hook and blade constructions) for use with the sport of fly fishing, it should be appreciated that this is for illustrative purposes only and that the present invention is suitable for use with other types of fishing activities, such as those employing open-face spinning reels or other implements in conjunction with which the present invention could be used. In addition, the particular artificial lures described herein are representative of those which may be employed to simulate various aquatic life forms. Broadly, the use of the term “aquatic life form” should be interpreted to mean aquatic life forms in their various life cycles stages, aquatic insects, small fish, leaches, salamanders, frogs, and crayfish, as well as terrestrial life forms adapted to live in or around an aquatic environment such as grasshoppers, beetles, ants, worms, or mice, but certainly any type of artificial lure for which the concepts of the present invention could be employed are contemplated, without restriction.

With the foregoing in mind, the present invention in one of its aspects relates to a fishhook which broadly comprises an elongated shank portion, a rigid eye portion adapted for attachment to a fishing line, a bend portion extending arcuately from the shank portion to terminate in a pointed tip and a blade or blade-like structure joined to and projecting away from the shank portion and preferably formed as a stiff, yet flexible material, such as plastic. As is contemplated, the rigid eyelet and the bend portion may share a common plane. However, an alternative fishhook construction is also contemplated such that the rigid eyelet is in a first plane and the bend portion is in a second plane perpendicular to the first plane. The term “blade” as used herein should be interpreted in the broadest sense possible to encompass any structure similar to those described herein which can be attached to a fishing hook for the purpose of interacting with water currents to impart life-like movement to an artificial fly whether separate from or in conjunction with other elements which comprise the fly body.

Joinder of the blade relative to the shank portion may be accomplished by a binding member that is disposed about the shank from which the blade extends at a selected angle, such as 45°, and preferably between 30° and 60°. This binding member may be formed integrally with the blade from a single piece of plastic construction, or other suitable material, or it may be a separate piece which is joined to the blade by a bonding agent such as a glue adhesive or the like. Further, the binding member may be a slotted piece received about the shank portion or molded directly to the shank portion. To facilitate tying of a fly body onto the fishhook, the binding member may also include a plurality of circumferential grooves formed therein which substantially encircle the shank portion so that fly tying materials can be more easily secured thereabout.

Together, the binding member and at least one blade joined thereto forms a blade-like structure that projects away from the shank portion. The blade portion, itself, can assume a variety of different positions on the shank portion and orientations relative thereto. For example, it can project forwardly beyond the shank portion's free end, which attaches to the fishing line, in either an upward or downward orientation. In addition, a plurality of blades can be joined to the binding member with these blades either diverging or converging towards one another in either an opposed or staggered relationship.

As mentioned above, the present invention also relates to an artificial lure for resembling an appearance of a selected aquatic life form at a particular stage of its life. The artificial lure broadly comprises a conventional fishhook, a body construction supported about at least a portion of the fishhook's shank and formed by an arrangement of fly tying materials that are tied about the portion of the shank in a selected pattern to resemble the appearance of a selected aquatic life form, and at least a first blade, as discussed above, joined to the fishhook. The blade is operative when the artificial lure is placed in water to interact with the water, either by the water's current or by the fisherman's manipulation of his line, and impart movement to the lure simulating life-like motion of the selected aquatic insect.

Another aspect of the present invention relates to a blade structure adapted for use with a fishhook that includes an elongated shank portion adapted for attachment to a fishing line, and a bend portion extending arcuately from said shank portion to terminate in a pointed tip. The blade structure includes a binding member adapted to be supported about a portion of the shank as well as at least one blade joined thereto. The blade projects from the binding member such that once the binding member is supported about the shank, the blade projects from the shank at an angle relative thereto.

Finally, the present invention relates to a method of creating an artificial lure which resembles an appearance of a selected aquatic life form at a particular stage of its life. Here, the method comprises providing a rigid fishhook including an elongated shank portion and a bend portion extending arcuately therefrom to terminate in a pointed tip, joining a blade-like structure to the shank portion, and forming a body for the aquatic life form by tying a plurality of fly tying materials onto the shank portion in a desired patterned arrangement resembling the appearance of the selected aquatic life form.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 is a perspective view of a fly fishing rod and reel assembly having attached thereto an artificial lure incorporating a first embodiment of the blade structure of the present invention;

FIG. 2 is an enlarged perspective view of the artificial lure shown in FIG. 1;

FIG. 3 is a diagrammatic illustration that represents the expected movement through water, as viewed from the side, of the artificial lure of FIG. 2;

FIG. 4 is a diagrammatic illustration that represents the expected movement through water, as viewed from the top, of the artificial lure of FIG. 2

FIG. 5 is a perspective view of the first embodiment of the blade structure according to the present invention that is used with the artificial lure of FIGS. 1 and 2;

FIG. 6 is a perspective view of the blade structure of FIG. 5 shown supported about a portion of a fishhook's shank;

FIG. 7 is a perspective view of the blade structure of FIGS. 5 and 6 showing the binding member thereof prior to securement about the fishhook's shank portion;

FIG. 8 is a perspective of the binding member shown in FIGS. 5 and 6, as viewed from the top, after securement about the fishhook's shank portion;

FIG. 9 is a front view in elevation of an alternative construction of a binding member;

FIG. 10 is a perspective view of yet another construction of the binding member;

FIG. 11 is a side view in elevation of the blade structure of FIGS. 5-7, and showing, in phantom, alternative positions thereof along the shank portion of a conventional fishhook;

FIG. 12 is a perspective view of a second exemplary embodiment of the blade structure according to the present invention shown supported about the shank portion;

FIG. 13 is a perspective view, as shown from the top, of the blade structure shown in FIG. 12;

FIG. 14 is a diagrammatic illustration that represents the expected movement through water, as viewed from the side, of an artificial lure that incorporates the blade structure of FIGS. 12 and 13;

FIG. 15 is a diagrammatic illustration that represents the expected movement through water, as viewed from the top, of an artificial lure that incorporates the blade structure of FIGS. 12 and 13;

FIG. 16 is a perspective view of an artificial lure according to the present invention that incorporates a third exemplary embodiment of the blade structure of the present invention;

FIG. 17 is a rear perspective view of an artificial lure that incorporates a fourth embodiment of the blade structure of the present invention;

FIG. 18 is a side view in elevation of an artificial lure that incorporates a fifth exemplary embodiment of the blade structure of the present invention;

FIG. 19 is a side view in elevation of an artificial lure that incorporates a sixth exemplary embodiment of the blade structure of the present invention;

FIG. 20 is a side view in elevation of an artificial lure that incorporates a seventh exemplary embodiment of the blade structure of the present invention;

FIG. 21 is a perspective view, as viewed from the top, of the blade structure of FIG. 20 shown supported about a portion of the shank of a fishhook;

FIG. 22 is a perspective view, as viewed from the top, of an eighth exemplary embodiment of the blade structure according to the present invention shown supported about a portion of the shank of a fishhook;

FIG. 23 is a perspective view, as viewed from the top, of a ninth embodiment of the blade structure according to the present invention shown supported about a portion of the shank of a fishhook;

FIG. 24 is a perspective view, as viewed from the top, of a tenth exemplary embodiment of the blade structure according to the present invention shown supported about a portion of the shank of a fishhook;

FIG. 25 is a perspective view, as viewed from the top, of an eleventh exemplary embodiment of the blade structure according to the present invention shown supported about a portion of the shank of a fishhook; and

FIG. 26 is a side view in elevation of a fishhook according to the present invention and a twelfth exemplary embodiment of the blade structure according to the present invention shown supported about a portion of its shank;

### DETAILED DESCRIPTION OF THE EXEMPLARY EMBODIMENTS

The present invention relates to artificial lures and fishhook constructions for use in the sport of fishing. In particular, the present invention relates to a device that may be used in conjunction with artificial lures and fishhooks to improve the presentation of an artificial lure in the water, whether on or below the water's surface, to better attract fish and increase one's chances of catching fish. Specifically, the present invention relates to blade structures that are constructed to contribute to the movement of the artificial lure as it is pulled through the water, or as a result of the artificial lure's interaction with the water currents.

The blade structure according to the present invention includes a binding member adapted to be disposed about a portion of a fishhook, typically at a location along the fishhook's shank, and a blade or fin extending therefrom. As is contemplated, when the binding member is supported about the fishhook, the blade projects away from the fishhook at an angle relative thereto so as to contribute to the movement of the artificial lure through the water.

The present invention contemplates a large variety of artificial lures and fishhook constructions that incorporate one or more blade structures to affect the presentation of the lure in the water. The blade structures of the present invention may be used to improve the presentation of artificial fly fishing lures and are also suitable for bait fishing.

Ideally, the angler will choose an artificial lure having an associated blade structure that will impart a movement to the lure that best imitates the life-like movement of a chosen aquatic life form. Broadly, the use of the term “aquatic life form” should be interpreted to mean life forms in their various life cycles stages, aquatic insects, small fish, leaches, salamanders, frogs, and crayfish, as well as terrestrial life forms adapted to live in or around an aquatic environment such as grasshoppers, beetles, ants, worms, or mice, but certainly any type of artificial lure for which the concepts of the present invention could be employed are contemplated, without restriction. Typically, the completed pattern of the selected aquatic life form will conceal the binding member from view while the blade may remain either partially or fully exposed. Preferably, the binding member and the blade are constructed of a clear plastic that will be invisible to the fish. The completed fly fishing lure may then be cast in a conventional manner.

Since the blade structures of the present invention are constructed to contribute to the movement of the artificial lure through the water, it should be apparent that different blade structures will impart different movements. Accordingly, a description that characterizes the expected movement believed to be contributed by each individual blade structure described below has been provided to further illustrate the invention. However, it should be appreciated that a variety of factors will often further influence the movement of the artificial lure while it is in the water such that it may vary from the expected movement described. For example, the strength of the water currents will influence the movement imparted by a particular blade structure. Other factors include the length of the fishhook, the type and weight of the fly pattern, the position of the blade structure relative to the main body portion of the fly pattern, whether weights or floaters are used, the angle of the blade(s), and the speed at which the angler pulls the lure through the water.

For the purpose of illustration, the present invention is specifically described herein with respect to selected insect patterns. However, it should be appreciated that the present invention can readily be adapted to a variety of other insect patterns known or used by fly anglers. Further, it should be appreciated that the applicability of present invention is not limited to artificial fly fishing lures for use with fly rods, but also contemplates use with various other types of artificial lures such as those used with open-face spinning reels or other implements.

In addition, for the sake of clarity and readability, the description of the present invention provided below discusses various exemplary embodiments of the blade structures according to the present invention. However, since the present invention also contemplates various embodiments of artificial lures and fishhook constructions that incorporate these blade structures, it should be appreciated that each embodiment of the blade structure described below further implies an alternative artificial lure embodiment as well as an alternative fishhook construction.

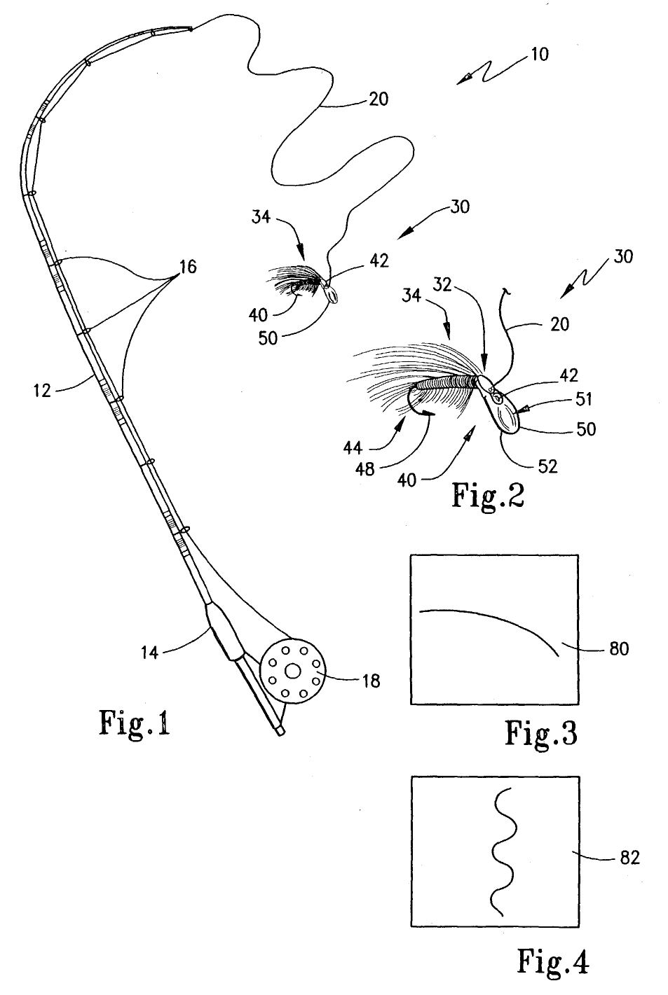

To better understand the construction of the blade structure and its ability to enhance the presentation of artificial lures in the water, reference is first made to FIGS. 1-5, which show a first exemplary embodiment of the blade structure and diagrammatic illustrations of the expected movement of the lure through the water. Turning first, then, to FIG. 1, fly fishing rod 10 is shown having a tapered, flexible pole 12 extending from handle grip 14. Pole 12 includes a plurality of fishing line guides 16 spaced-apart along its length. Reel 18 is mounted adjacent to handle grip 14 and retains fishing line 20 in a conventional manner. Fishing line 20 is threaded through each of line guides 16 and extends beyond the distal end of pole 12 where its free end is connected to artificial lure 30 via eyelet 42. Artificial lure 30 includes blade 50 extending at an angle relative to body portion 34. Where the present invention is used in connection with the sport of fly fishing, it is understood that the “fishing line” to which the artificial lure is tied would actually include a fly line, which itself can take on a variety of different forms, as well as a leader line and perhaps a tippet. As such, the artificial lure is actually tied directly to the end of either the leader line or the tippet. Other types of fishing may utilize a different type of line construction so that the term “fishing line” as used herein should be interpreted in its broadest sense possible without limitation. As perhaps best shown in FIG. 2, artificial lure 30 is in the form of one of a variety of streamers. A streamer generally refers to a type of swimming aquatic life form, such as a small fish, leach, and the like, that appeals to fresh water fish such as trout. As is known by the ordinarily skilled angler, a streamer pattern, like many other insect patterns, is tied directly onto conventional fishhook 40 (only a portion of which is shown) in an intricate array of materials such as feathers and fur so as to create a segmented insect body. For example, artificial lure 30 includes a head portion 32 and a body portion 34.

With continued reference to FIG. 2, artificial lure 30 is shown to include blade 50, according to a first exemplary embodiment, as well as a first embodiment of an artificial lure. Blade 50 extends at an angle relative to body portion 34 and is in spaced relation to bend portion 44 and pointed tip 48 of fishhook 40 so as not to interfere with the ability to catch the fish. More specifically, blade 50 is located adjacent to eyelet 42 and extends downwardly and forwardly from body portion 34 at approximately a 45° angle. Further, as shown, blade 50 is in the shape of a teardrop or spoon and has a curved outer surface 52 that creates concavity 51. Concavity 51 of outer surface 52 may be varied to be either slightly or more pronounced depending upon the desired action of the fly.

As a result of the placement of blade 50 adjacent to eyelet 42, the angle at which blade 50 is positioned, and concavity 51 of blade 50, as described, blade 50 will impart a movement to artificial lure 30 as artificial lure 30 moves through the water. FIGS. 3 and 4 show a diagrammatic representation of the expected movement of artificial lure 30 when viewed from the side and from the top respectively.

Turning first to FIG. 3, a diagrammatic representation is shown illustrating that artificial lure 30 is expected to I follow a gradual downward path 80, diving deeper and deeper below the water's surface. It should be apparent that once artificial lure 30 ceases to move through the water, it will no longer follow this anticipated downward trajectory, dictated in part by the amount of sinking or floating material applied in tying the pattern, and will eventually drift upward to return to its stationary position. Further, it is believed that a succession of movement and cessation of artificial lure 30 will cause it to assume an up and down wavelike motion.

Not only is it expected that blade 50 will cause artificial lure 30 to dive beneath the water's surface, but, as shown in the diagrammatic representation of FIG. 4, it is also expected to impart a side-to side-movement. Accordingly, as artificial lure 30 dives beneath the water's surface, it is believed that it will also assume path 82 and wiggle back and forth so that artificial lure 30 appears to “swim” down through the water. To reiterate, this description is simply a characterization of the expected movement believed to be imparted to artificial lure 30 by blade structure 70 and does not take into consideration other extraneous factors that may cause the lure to stray from this expected path.

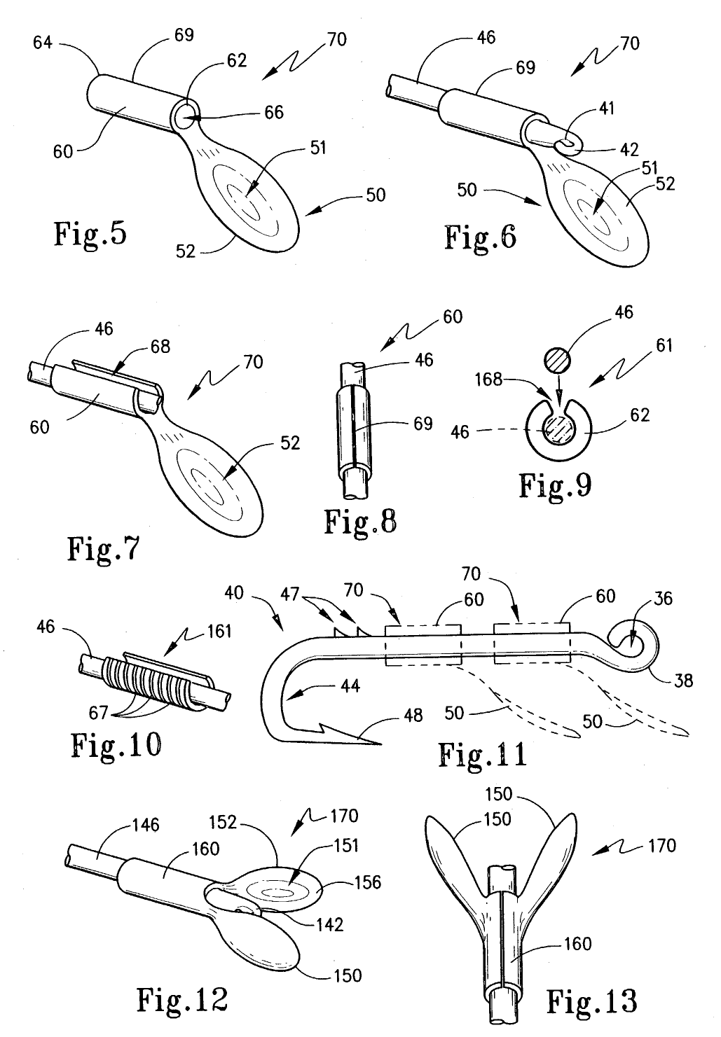

In order to better understand the features of blade 50 and the manner in which it is supported by a conventional fishhook, it is perhaps best helpful to describe blade 50, along with its other features, apart from the completed streamer pattern of artificial lure 30. Accordingly then, with reference to FIG. 5, blade structure 70 is shown to comprise blade 50 as well as binding member 60. Binding member 60 is not shown in FIG. 2 because it is concealed from view by the streamer fly pattern that has been tied about it. Blade 50 and binding member 60 may be formed as a one-piece integral construction of a stiff, yet flexible material such as plastic by an injection molding process, for example. Alternatively, blade 50 and binding member 60 may be formed as two separate pieces that are then joined either by an adhesive such as glue, or by other appropriate means such as heat.

With continued reference to FIG. 5, blade 50 extends from front end 62 of binding member 60 at an angle relative thereto. As shown in this particular embodiment, blade 50 is at an angle of approximately 45°; however, it should be appreciated that blade 50 may extend at any desirable angle and preferably an angle between 30° and 60°. Further, it should be appreciated that blade 50 may extend from binding member 60 at any location along its length as well as from back end 64.

With continued reference to FIG. 5, and with additional reference to FIGS. 6-8, binding member 60 is generally constructed as a sleeve having hollow interior 66. Binding member 60 also includes lengthwise slit 68 that extends along the entire length of binding member 60 and is adapted to receive shank portion 46. Once shank portion 46 passes through slit 68 and is positioned within hollow interior 66, slit 68 may be closed about shank portion 46 to form crease 69. The present invention contemplates manufacturing a conventional fishhook such that blade structure 70 is directly formed thereon. In this way, slit 68 could be heat-sealed to form crease 69. However, it should be appreciated that there are a variety of different ways in which binding member 60 may be secured about shank 46. For example, if binding member 60 was formed of a stiff, yet flexible plastic, one may press it closed about shank 46 to form crease 69. Alternatively, as shown in FIG. 9, binding member 61 is a snap fit or press fit piece that permits passage of shank 46 through passageway 168 when shank 46 is forced through. A binding member could also be formed without a lengthwise slit and have an opening on either side that is large enough to receive the eyelet and shank of the fishhook. Once the eyelet passes through the openings and the binding member is placed at a desirable location along the shank, it may be secured into place with an adhesive such as glue, epoxy, and the like.

Preferably, binding member 60 is sized such that it will tightly encircle a portion of shank 46 to prevent blade structure 70 from moving during use. However, it should also be appreciated that any number of adhesives such as glue and the like may be additionally used to keep binding member 60 in place.

However, an alternative embodiment of binding member 60, which is constructed to aid in tying a fly pattern about the binding member, is shown in FIG. 10. As shown, binding member 61 includes circumferential grooves 67 formed therein that provide a rippled surface contour. Grooves 67 act as an aid to an angler for tying the desired insect pattern about binding member 61 such that the fly tying material is well secured to binding member 61 and better conceals binding member 61 from view. It should be appreciated that the number of grooves 67 and the distance in which they are spaced apart may be varied depending upon the application.

As mentioned above with respect to the first embodiment of the blade structure, binding member 60 may be positioned adjacent to eyelet 42 of a fishhook such that blade 50 extends directly underneath eyelet 42. However, binding member 60 is not confined to this location. Rather, as represented in FIG. 11, binding member 60, shown in phantom, may be positioned at multiple locations along the length of shank 46 of conventional fishhook 40. Ideally, binding member 60 would be positioned such that blade 60 does not obstruct pointed tip 48. Further, as should be understood, the present invention also contemplates using multiple blade structures 70 at one time. As should be understood, FIG. 11 also shows an alternative fishhook construction as contemplated by the present invention.

With continued reference to FIG. 11, it should be appreciated that a blade structure according to the present invention may be used with any of a variety of fishhooks or fishhook components known or used by anglers. For example, fishhook 40 may include barbs 47. Barbs 47 aid in keeping live or artificial worms, eggs, and the like attached to the hook. Additionally, any variety of weights or “sinkers” may be added to fishhook 40 or even molded directly over the binding member, to impart a jigging action. The additional weight provided thereby alters the movement of the lure that is imparted by the blade structure. For example, as described above with reference to FIGS. 2-6, blade structure 70 is expected to cause artificial lure 30 to follow a certain downward trajectory through the water as represented by FIG. 3. However, by adding weights, it is expected that artificial lure 30 will follow a steeper downward trajectory than shown in FIG. 3.

With continued reference to FIG. 11, alternative configurations of the fishhook's eyelet are also contemplated and may further influence the movement of the lure that is imparted by the blade structure. For example, in FIG. 11, eyelet 38 extends arcuately upwardly from shank 46 to form eyelet opening 36. By contrast, in FIG. 6, eyelet 42 extends arcuately and to the side of shank 46 to form eyelet opening 41. Accordingly, eyelet 38 and eyelet 42 are oriented at 90° relative to each other. As a result of this difference, it is believed that eyelet 38 will offer a different contribution to a lure's movement than eyelet 42. More specifically, the turning of the eyelet to a vertical orientation, as shown in FIG. 11, provides a new type of fishhook for use in tying flies. The vertical orientation of the fishhook's eyelet enhances the swimming action imparted by the blade when such action is intended to be side-to-side.

A second exemplary embodiment of the blade structure is shown in FIGS. 12 and 13. As shown, blade structure 170 includes a pair of opposed blades 150 and binding member 160 supported about shank 146. Blades 150 diverge outwardly from each other and away from binding member 160 on either side of eyelet 142. As perhaps best shown in FIG. 12, blades 150 project outwardly from shank 146, but not downwardly therefrom. Blades 150 are in the shape of a teardrop or spoon, and additionally may include concavity 151 in outer surface 152.

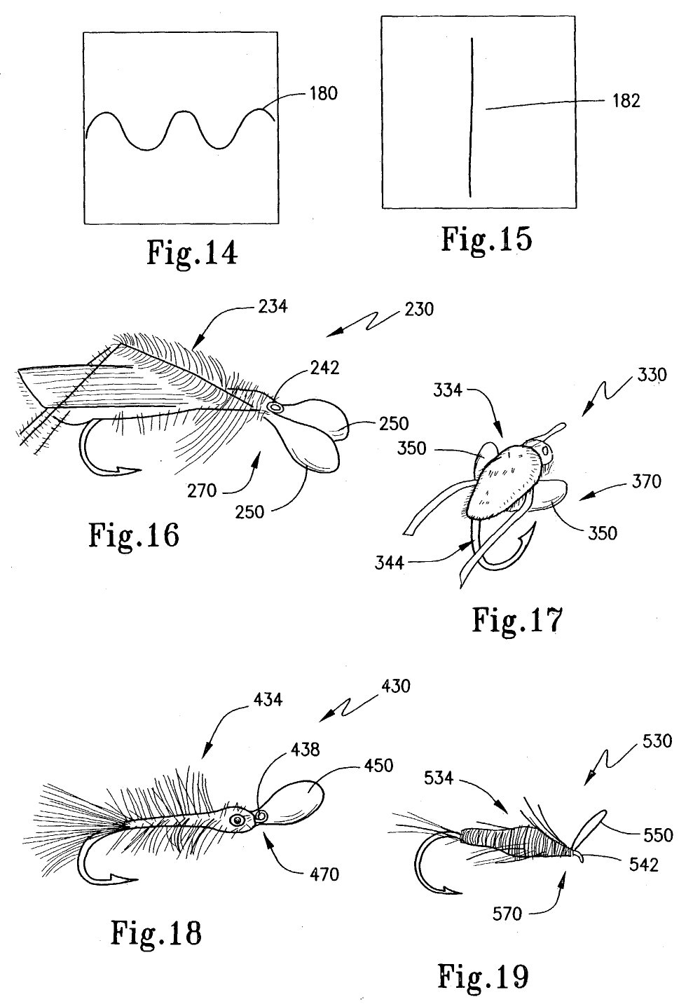

As should be expected, blade structure 170 will impart a movement to an artificial lure that is different than the movement described above with respect to blade structure 70. More specifically, FIGS. 14 and 15, respectively, show diagrammatic representations believed to be the expected path 180 and 182 that an artificial lure might follow as a result of blade structure 170 when viewed from the side and from the top. As shown in FIG. 14, it is believed that blade structure 170 would cause an artificial lure to undulate through the water with a succession of an up and down wavelike movements. However, as represented in FIG. 15, the artificial lure will probably have little, if any side-to-side motion. This particular swimming motion mimics the movement of a leach and some species of nymphs.

Modifying either the position of blades 150 relative to shank 146, or the position of binding member 160 about shank 146 is believed to offer different contributions to the movement of a lure. For example, as shown in FIG. 16, an alternative artificial lure 230, which replicates a grasshopper, has a blade structure according to a third exemplary embodiment. Blade structure 270 has opposing blades 250 that extend outwardly from body portion 234 on either side of eyelet 242, and a binding member that is not visible due to the insect pattern. Blade structure 270 of FIG. 16 differs from blade structure 170 described above with reference to FIGS. 12 and 13 in that blades 250 extend downwardly from at an angle relative to body portion 234 at approximately a 45° angle. It is believed that blade structure 270 will impart a more erratic swimming motion to artificial lure 230, due to the difference in the angle of the blades, and will tend to follow a gradual downward trajectory. This swimming motion is intended to simulate the movement of a terrestrial insect in the water, such as a grasshopper.

With respect to FIG. 17, a blade structure according to a fourth exemplary embodiment is shown with artificial lure 330, which is in the form of a beetle. Here again, blade structure 370 includes opposing blades 350 that extend outwardly from body portion 334 and a binding member that is not visible due to the insect pattern. Blade structure 370 is located closer to bend portion 344 and more in line with the lure's center of gravity such that blades 350 extend away from the mid section of body portion 334 rather than on either side of the eyelet as described above. While it is anticipated that blade structure 370 will impart a similar swimming action to lure 330 as that described above with reference to grasshopper 230, its location with respect to lure 330 is expected to offer more stability such that its movement may be somewhat less erratic. Furthermore, although not shown, relocating blade structure even farther away from the eyelet such that it is adjacent to bend portion 344 might provide even more stability for some lures resulting in an even more relaxed swimming motion that is characteristic, for example, of a sow bug or leach. Of course, varying the positioning of the blade structure and the consequent movement imparted thereby will depend in part upon the size and weight of the lure as well as the location of the blade structure with respect to the lure's center of gravity.

Proceeding next to FIG. 18, artificial lure 430 is shown with blade structure 470 according to a fifth exemplary embodiment. Here, blade structure 470 includes a single blade 450 extending away from body portion 434 on one side of eyelet 438. Blade structure 470 will cause artificial lure 440 to assume the wavelike swimming action illustrated in FIG. 14, however, in the absence of a second opposing blade extending on the other side eyelet 438, it is believed that artificial lure 440 will veer sideways as it moves through the water. As shown in FIG. 18, one possible fly pattern that is associated with the movement imparted by blade structure 470 would be the wooly bugger.

As mentioned above, the mayfly insect pattern is perhaps one of the most important insect patterns for fly fishing. Insect patterns try to replicate the mayfly during stages of its life cycle such as the nymph, dun, and spinner stages. Accordingly, the present invention contemplates artificial lures that replicate various life stages of the mayfly and which also incorporate a blade structure to improve its presentation. For example, with respect to FIG. 19, an artificial lure in the form of a mayfly nymph 530 is shown with blade structure 570 according to a sixth embodiment. During the nymph stage, the mayfly swims about in the water, and as it matures, the nymph typically drifts or swims to the surface to “emerge”. Accordingly, blade structure 570 includes a single blade 550 that is positioned on top of body portion 534 and extending above and away from eyelet 542. It is believed that if properly weighted, nymph 530 will rest on the bottom of the water body and, as it is pulled through the water, blade structure 570 will cause it to swim upward, or emerge.

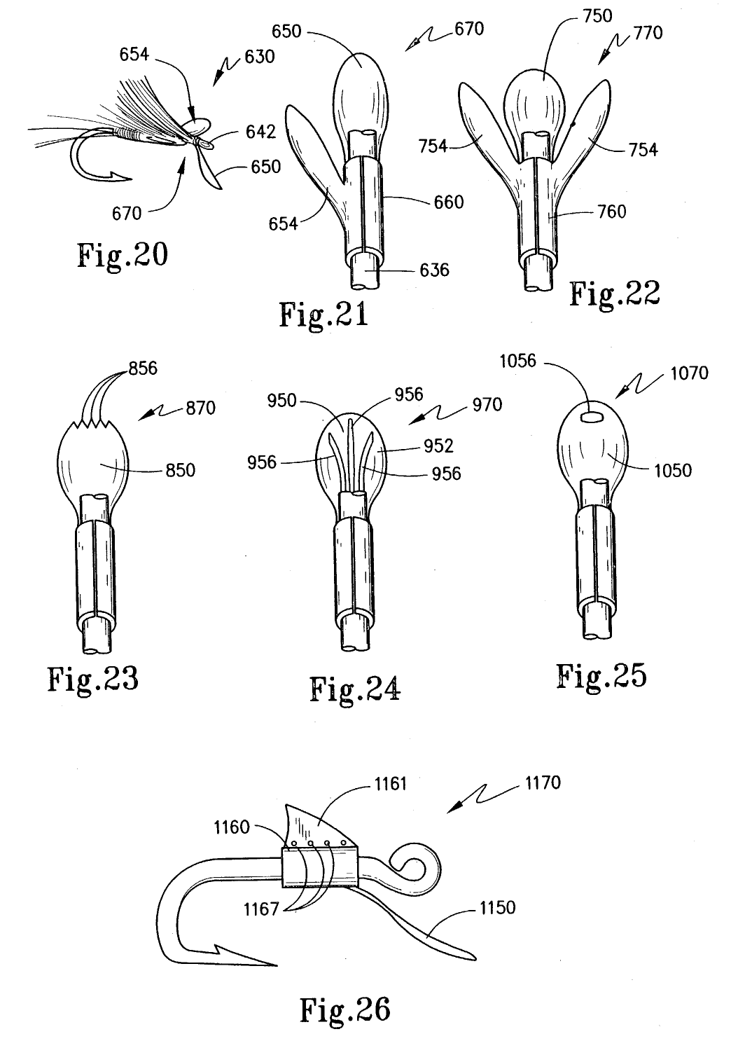

After the nymph reaches the surface of the water, it sheds its underwater body to reveal a pair of wings, marking its entry into the dun stage. In FIG. 20, an artificial lure resembling a mayfly dun 630 is shown with blade structure 670 according to a seventh embodiment, which is best shown in FIG. 21. Blade structure 670 includes blades 650 and 654. Blade 650 extends downwardly and outwardly from beneath eyelet 642 (as shown in FIG. 20). Blade 654, on the other hand, extends from the mid portion of binding member 660 so that when binding member 660 is positioned on shank 636, and the insect pattern is completed, blade 654 will extend from the mid section of body portion 634. It is anticipated that blade structure 670 will impart a very odd jerking motion and a slight downward diving action to dun 630. This motion would, in effect, imitate the mayfly shedding its underwater body as it emerges into the dun stage.

Several other blade structures contemplated by the present invention are shown supported about a portion of a fishhook in remaining FIGS. 21-26. With respect to FIG. 22, triple blade structure 770, according to an eighth embodiment, includes three blades, central blade 750 and side blades 754, which extend on either side of binding member 760 to flank central blade 750. Triple blade structure 770, in effect, combines the respective movements of the blade structures described above with reference to the diagrammatic representations of FIGS. 3 and 4 and FIGS. 14 and 15. Accordingly, it is believed that triple blade structure 770 will cause an artificial lure to undulate through the water as it dives downwardly from the surface, while at the same time, imparting a side-to-side swimming motion.

In FIG. 23, blade structure 870, according to a ninth embodiment includes a single blade 850 with teeth 856 formed along the distal end portion. As described above with reference to FIGS. 3 and 4, a single blade structure without teeth 856 is expected to impart a gradual downward dividing action coupled with a side-to-side movement. Blade structure 870 is believed to also impart a downward diving action coupled with a side-to-side movement, however, it is also expected that teeth 856 will add an erratic motion to both the downward and side-to-side swimming motion as the artificial lure moves through the water.

Turning next to FIG. 24, an alternative single blade structure 970, according to a tenth embodiment, is shown which is also expected to impart a downward diving action coupled with a side-to-side movement. However, in this embodiment, single blade 950 includes rib portions 956 associated with outer surface 952. It should be understood that rib portions 956 may either protrude from outer surface 952 or may be formed therein. It is believed that rib portions 956 will add an erratic swimming motion to both the downward diving action and the side-to-side movement similar to that described above with reference to FIG. 23. However, in contrast to blade 850 with teeth 856, it is anticipated that the downward diving action imparted by rib portions 956 will be less erratic than that imparted by teeth 856.

FIG. 25 shows an eleventh exemplary embodiment of the blade structure. Blade structure 1070 includes a single blade 1050 with aperture 1056 formed therethrough. As shown, aperture 1056 is located near the distal edge of blade 1050. It should be understood, however, that aperture 1056 is not confined to this location, nor is it limited to the size or shape represented in FIG. 25. Again, as described above, single blade 1050 is expected to impart a downward diving action coupled with a side-to-side movement. Depending, of course, upon the size and location of the aperture, this movement may vary. However, with respect to the size and location of aperture 1056, as shown, it is believed that it will contribute more to the sound of the lure as it moves through the water such that it might be useful, for example, to imitate a wounded minnow.

Finally, FIG. 26 shows a twelfth exemplary embodiment of the blade structure and an alternative fishhook construction. Again, a single blade 1150 extends from binding member 1160. As shown, however, in this embodiment, binding member 1160 includes dorsal fin 1161 extending upwardly therefrom. Dorsal fin 1161 also includes apertures 1167 at its base. Again, blade 1150 is anticipated to impart a downward dividing action coupled with a side-to-side movement. It is believed that dorsal fin 1161 may enhance the stability of the artificial lure as it moves through the water. In addition, as is contemplated, dorsal fin 1161 may also be flanked by a pair of side fins, not shown, which may further contribute to the stability of the artificial lure Of course, the contribution made by dorsal fin 1161 or side fins, will be dependent, in part, upon the length of the fishhook and the size and weight of the lure.

Finally, the present invention relates to a method of creating an artificial lure that resembles an appearance of a selected aquatic life form at a particular stage of its life. Here, the method comprises providing a rigid fishhook including an elongated shank portion and a bend portion extending arcuately therefrom to terminate in a pointed tip, joining a blade-like structure to the shank portion, and forming a body for the aquatic life form by tying a plurality of fly tying materials onto the shank portion in a desired patterned arrangement resembling the appearance of the selected aquatic life form.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

I claim:

1. A fishhook, comprising:
a. an elongated shank portion adapted for attachment to a fishing line;
b. a bend portion extending arcuately from said shank portion to terminate in a pointed tip; and
c. a blade joined relative to and projecting away from said shank portion.

2. A fishhook according to claim 1 wherein said blade is formed from a stiff material.

3. A fishhook according to claim 2 wherein said stiff material is flexible.

4. A fishhook according to claim 2 wherein said material is plastic.

5. A fishhook according to claim 1 wherein said blade is joined relative to said shank portion by a binding member.

6. A fishhook according to claim 5 wherein said binding member is disposed about said shank portion and said blade extends from said binding member.

7. A fishhook according to claim 6 wherein said binding member is a slotted piece received about said shank portion.

8. A fishhook according to claim 6 wherein said binding member is molded to said shank portion

9. A fishhook according to claim 5 wherein said binding member includes a plurality of circumferential grooves formed therein which substantially encircle said shank portion.

10. A fishhook according to claim 5 wherein said blade and said binding member are each formed of plastic material.

11. A fishhook according to claim 10 wherein said blade and said binding member are formed integrally as a single piece construction.

12. A fishhook according to claim 10 wherein said blade and said binding member are formed by separate pieces that are joined together by a bonding agent.

13. A fishhook according to claim 1 including a pair of blades joined to and projecting away from said shank portion.

14. A fishhook, comprising:
a. an elongated shank portion having a free end adapted for attachment to a fishing line;
b. a bend portion extending arcuately and downwardly away from said shank portion to terminate in a pointed tip; and
c. a blade structure supported about shank portion.

15. A fishhook according to claim 14 wherein said blade structure includes a binding member disposed about said shank portion and at least one blade joined to said binding member.

16. A fishhook according to claim 14 wherein said blade structure projects forwardly beyond said fee end.

17. A fishhook according to any one of claims 15 & 16 wherein said blade structure projects upwardly from said shank portion.

18. A fishhook according to any one of claims 15 & 16 wherein said blade structure projects downwardly from said shank portion.

19. A fishhook according to claim 15 including a plurality of blades joined to said binding member.

20. A fishhook according to claim 19 wherein said blades diverge away from one another on opposite lateral sides of said shank portion.

21. A fishhook according to claim 19 wherein said blades converge towards one another on opposite lateral sides of said shank portion.

22. A fishhook according to claim 19 wherein said blades are positioned in opposed relationship with one another on opposite lateral sides of said shank portion.

23. A fishhook according to claim 19 wherein said blades are staggered along a length of said shank portion.

24. A fishhook according to claim 19 wherein said binding member is a slotted piece received about said shank portion and includes a plurality of circumferential grooves formed therein which substantially encircle said shank portion.

25. A fishhook according to claim 19 wherein said binding member is molded to said shank portion.

26. A fishhook according to claim 19 wherein said binding member and each of said blades is constructed from a stiff, yet flexible plastic material.

27. A fishhook, comprising:
a. an elongated and rigid shank extending along a longitudinal axis;
b. a rigid eyelet formed integrally with a first end of said shank for attachment to a fishing line;
c. a rigid bend portion formed integrally with a second end of said shank and extending arcuately and downwardly therefrom to terminate in a pointed tip; and
d. a stiff first blade joined to and projecting away from said shank proximate to said first end.

28. A fishhook according to claim 27 including a stiff second blade joined to and projecting away from said shank.

29. A fishhook according to claim 28 wherein said first and second blades diverge away from one another on opposite lateral sides of said shank portion.

30. A fishhook according to claim 28 wherein said first and second blades converge towards one another on opposite lateral sides of said shank portion.

31. A fishhook according to any one of claims 29 & 30 wherein said first and second blades are positioned in opposed relationship with one another.

32. A fishhook according to claim 29 & 30 wherein said first and second blades are staggered along a length of said shank portion.

33. A fishhook according to claim 28 wherein said first and second blades are joined to said shank by a binding member which is disposed about said shank.

34. A fishhook according to claim 27 wherein said rigid eyelet and said bend portion are in a common plane.

35. A fishhook according to claim 27 wherein said rigid eyelet is in a first plane and said bend portion is in a second plane that is perpendicular to the first plane.

36. In a fishhook including an elongated and rigid shank extending along a longitudinal axis, a rigid eyelet formed integrally with a first end of said shank for attachment to a fishing line, a rigid bend portion formed integrally with a second end of said shank and extending arcuately therefrom to terminate in a pointed tip, the improvement comprising at least one blade joined to and projecting away from said shank.

37. An artificial fishing lure for resembling an appearance of a selected aquatic insect at a particular stage of its life, comprising:
a. a rigid fishhook formed integrally from a selected material, said fishhook including:
(i) an eyelet adapted for attachment to a fishing line;
(ii) a elongated shank joined to said eyelet and extending along a longitudinal axis;
(iii) a bend joined to said shank and extending arcuately therefrom to terminate in a pointed tip portion that includes a barb;
b. a body construction supported on least a portion of said shank and formed by an arrangement of fly tying materials that are tied about said portion of the shank in a selected pattern to resemble the appearance of the selected aquatic insect; and
c. at least a first blade joined to said fishhook and operative when said artificial fishing lure is placed in moving water to interact with the water and impart movement to said lure.

38. An artificial fishing lure according to claim 37 wherein said first blade is joined to said fishhook by a binding member disposed about said shank.

39. An artificial fishing lure according to claim 38 wherein said binding member is located in close proximity to said eyelet.

40. An artificial fishing lure according to claim 38 including a plurality of circumferential grooves formed in said binding member for providing a rippled surface contour about which said fly tying materials are wound.

41. An artificial fishing lure according to claim 38 including a second blade joined to said binding member and operative in conjunction with said first blade when said artificial fishing lure is placed in moving water to interact with the water and impart movement to said lure.

42. A blade structure adapted for use with a fishhook that includes an elongated shank portion adapted for attachment to a fishing line, and a bend portion extending arcuately from said shank portion to terminate in a pointed tip, comprising:
a. a binding member adapted to be supported about said shank portion; and
b. at least one blade joined to said binding member and projecting from said binding member at an angle relative thereto such that when said binding member is supported about said shank portion, said blade projects from said shank at an angle relative thereto.

43. A blade structure according to claim 42 wherein said binding member has a lengthwise slit configured to receive a portion of said fishhook.

44. A blade structure according to claim 42 wherein said blade is at a 45° angle with respect to said binding member.

45. A method of creating an artificial lure which resembles an appearance of a selected aquatic life form at a particular stage of its life, comprising:
a. providing a rigid fishhook which includes an elongated shank portion and a bend portion extending arcuately therefrom to terminate in a pointed tip;
b. joining a blade structure to said shank portion; and
c. forming a body for the life form by tying a plurality of fly tying materials onto said shank portion in a desired patterned arrangement resembling the appearance of the selected aquatic life form.
